(19) United States
(12) Patent Application Publication
(10) Pub. No.: US 2026/0237272 A1
(43) Pub. Date: Aug. 13, 2026

(54) METHOD AND SYSTEM FOR A GAME OF CHANCE

(71) Applicant: Bluberi Gaming Canada Inc., Drummondville (CA)

(72) Inventor: Carl NADEAU, Drummondville (CA)

(21) Appl. No.: 19/534,151

(22) Filed: Feb. 9, 2026

Related U.S. Application Data
(60) Provisional application No. 63/756,564, filed on Feb. 10, 2025.

(51) Int. Cl. G07F 17/32

(52) U.S. Cl. CPC G07F 17/329

(57) ABSTRACT

A method for a game of chance. The method includes populating a plurality of first game symbols in a plurality of first symbol locations. Determining whether a first division condition has been met based on the plurality of first game symbols in the plurality of first symbol locations. Sub-dividing at least one first symbol location to include a plurality of second symbol locations, and populating a second game symbol in the plurality of second symbol locations when the first division condition has been met. Determining whether a second division condition has been met based on the second game symbol in the plurality of second symbol locations. Sub-dividing the at least one first symbol location to include a plurality of third symbol locations, and populating a third game symbol in the plurality of third symbol locations.

### CROSS-REFERENCE TO RELATED APPLICATIONS

This utility patent application claims the benefit of and priority to U.S. provisional patent application, serial no. 63/756,564, filed on February 10, 2025, the entire disclosure of which is hereby incorporated by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all rights.

### TECHNICAL FIELD

The present disclosure relates to gaming systems and gaming machines through which players may participate in wagering games. More particularly the present disclosure relates to a method and system for a game of chance.

### BACKGROUND

Generally, the popularity of casino gaming machines (e.g., slot machines) and other casino games depends on both a player’s perceived likelihood of winning and the game’s entertainment value relative to other available options. Casinos offer numerous competing machines, and players also have access to many online and mobile gaming experiences. Players gravitate toward the most engaging and exciting games, especially those that create a sense of higher potential for large prizes. Accordingly, there is a continuing need to develop gaming machines that deliver enhanced entertainment and heightened anticipation of significant wins.

### SUMMARY OF THE DISCLOSURE

According to an aspect of the disclosure, a method for a game of chance is provided. The method includes populating a plurality of first game symbols in a plurality of first symbol locations. The method also includes determining whether a first division condition has been met based on the plurality of first game symbols in the plurality of first symbol locations. The method also includes sub-dividing at least one first symbol location to include a plurality of second symbol locations, and populating a second game symbol in the plurality of second symbol locations when the first division condition has been met. The method also includes determining whether a second division condition has been met based on the second game symbol in the plurality of second symbol locations. The method also includes sub-dividing the at least one first symbol location to include a plurality of third symbol locations, and populating a third game symbol in the plurality of third symbol locations.

According to another aspect of the disclosure, a system for a game of chance is provided. The system includes at least one graphical user interface for displaying aspects of the game of chance to users, at least one input device for receiving inputs from the users, one or more memory devices storing instructions, and one or more processing devices communicatively coupled to the at least one graphical user interface, the at least one input device, and the one or more memory devices. The one or more processing devices execute the instructions to populate a plurality of first game symbols in a plurality of first symbol locations. The instructions include determining whether a first division condition has been met based on the plurality of first game symbols in the plurality of first symbol locations. The instructions also includes sub-dividing at least one first symbol location to include a plurality of second symbol locations and populate a second game symbol in the plurality of second symbol locations when the first division condition has been met. The instructions also include determining whether a second division condition has been met based on the second game symbol in the plurality of second symbol locations. The instructions also include sub-dividing the at least one first symbol location to include a plurality of third symbol locations and populate a third game symbol in the plurality of third symbol locations.

According to another aspect of the disclosure, a tangible, non-transitory computer-readable medium is provided which stores instructions that, when executed, cause one or more processing devices to populate a plurality of first game symbols in a plurality of first symbol locations. The instructions also determine whether a first division condition has been met based on the plurality of first game symbols in the plurality of first symbol locations. The instructions also sub-divide at least one first symbol location to include a plurality of second symbol locations and populate a second game symbol in the plurality of second symbol locations when the first division condition has been met. The instructions also determine whether a second division condition has been met based on the second game symbol in the plurality of second symbol locations. The instructions also sub-divide the at least one first symbol location to include a plurality of third symbol locations and populate a third game symbol in the plurality of third symbol locations.

The method and system for a game of chance repeatedly sub-divides symbol locations and increases the amount of game symbols when a sub-division condition has been met. This builds the anticipation of a big win for a player and makes the gaming experience more engaging and exciting.

### BRIEF DESCRIPTION OF THE DRAWINGS

In the following description, details are set forth to provide an understanding of the present disclosure and are not intended to limit the scope of the present disclosure. In some instances, certain systems, structures and techniques have not been described or shown in detail in order not to obscure the disclosure.

FIG. 1A illustrates a game display of a system for a game of chance, according to an embodiment of the present disclosure;

FIG. 1B illustrates a block diagram of the game display for the system for a game of chance according to an embodiment of the present disclosure;

FIG. 1C illustrates a play area of the game display of the system for a game of chance, according to an embodiment of the present disclosure;

FIG. 2A illustrates a sub-division feature of the system for a game of chance play, according to an embodiment of the present disclosure;

FIG. 2B is a block diagram illustrating the sub-division feature of the system for a game of chance as shown in FIG. 2A;

FIG. 3A–3G illustrates the progression of game play for the system for a game of chance, according to an embodiment of the present disclosure;

FIG. 4 is a block diagram of a method for a game of chance, according to an embodiment of the present disclosure;

FIG. 5 is a block diagram of an example computing device that may be used to implement embodiments, according to the principles of the present disclosure; and

FIG. 6 depicts an example gaming machine that may be used to implement embodiments, according to the principles of the present disclosure.

### DETAILED DESCRIPTION OF THE ENABLING EMBODIMENTS

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

The following detailed description is merely exemplary in nature and is not intended to limit the invention or the application and uses of the invention. The methods, systems, and apparatuses are described herein with respect to an exemplary game of chance “Pirate’s LockTM” having a cartoon pirate theme. However, one of ordinary skill in the art will understand that the methods, systems, and apparatuses may also be used with other games of chance, prize awarding, lotteries, video games or other types of games, or the like.

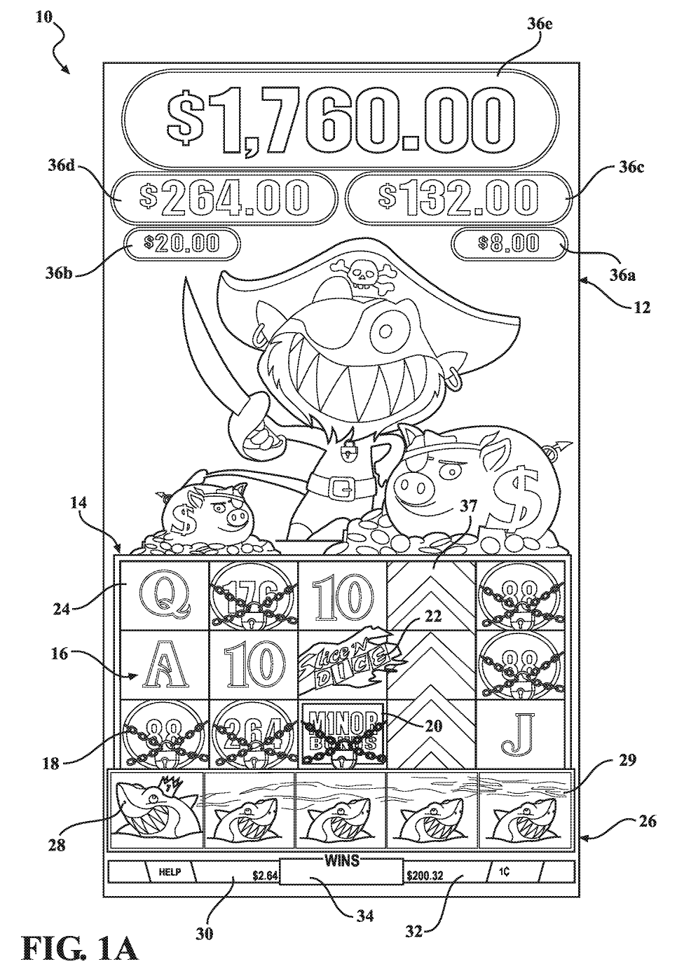

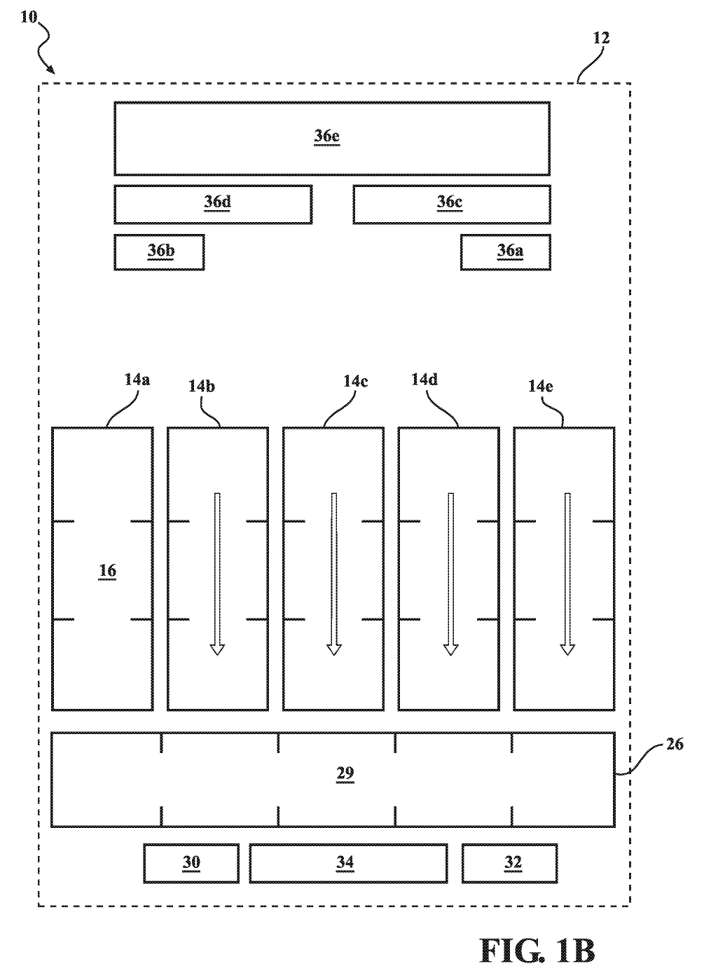

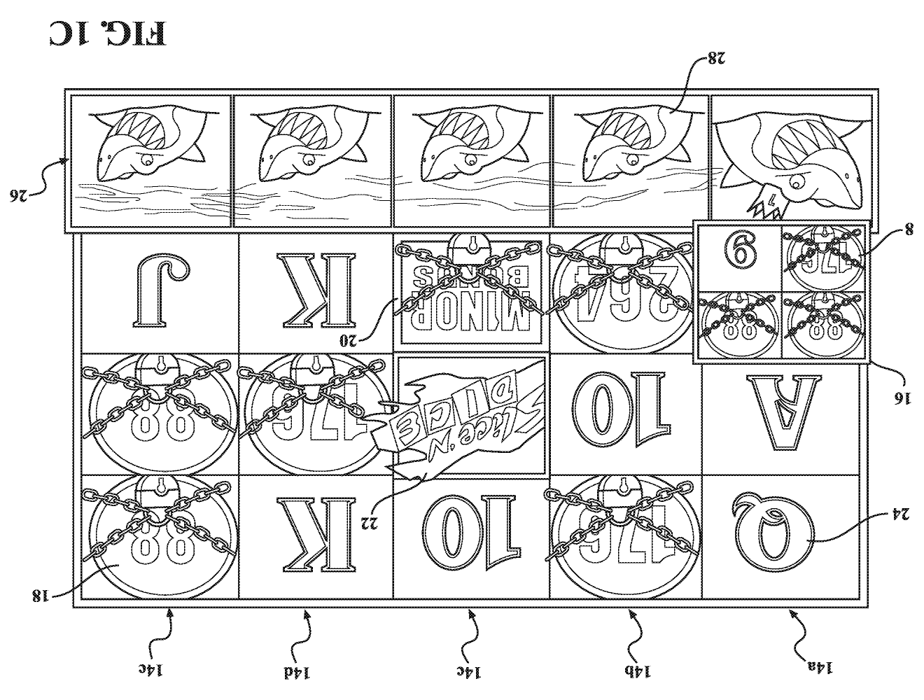

As shown in FIG. 1A, a system 10 for a game of chance may be facilitated on a gaming machine that includes a display 12. The display 12 is configured to present information related to the system 10 for a game of chance to a user. According to an example embodiment, the display 12 may be the monitor for a gaming kiosk found in a casino, however the display 12 may be any graphical user interface including, but not limited to, screens of smart phones, tablets, or personal computers. According to an embodiment of the present disclosure, the display 12 may be any type of displThe display 12 may include a plurality of reels 14, wherein the plurality of reels 14 each include a plurality of symbol locations 16 for featuring various game symbols, such as a prize token 18, a bonus token 20, a first trigger token 22, and general tokens 24. The plurality of reels 14 may resemble a column in which the game symbols are stacked in vertical alignment with one another. According to an aspect, the display 12 may include boxes (or other symbols) for illustrating a player’s wager 30, credits 32, prize winnings 34, or the like. The display 12 may further include boxes for representing bonus prize amounts of the bonus token 20, such as a mini bonus amount 36a, a minor bonus amount 36b, a maxi bonus amount 36c, a major bonus amount 36d, and grand bonus amount 36e, or the like.

As shown in FIG. 1B, the plurality of reels 14a-e are shown with an arrow to indicate rotation, wherein the game symbols may rotate within a respective one of the plurality of symbol locations 16 and/or across the plurality of symbol locations 16 to represent a simulated spin of the plurality of reels 14. The plurality of reels 14 may be arranged adjacent to one another, such that the plurality of symbol locations 16 define a grid. For example, a 5x3 grid may be formed from five reels 14 having three symbol locations 16. Any number of reels 14 and/or symbol locations 16 may be used and displayed on the display 12 in close proximity or spaced apart from each other.

As shown in FIG. 1C, in some embodiments of the system 10 for a game of chance, the display 12 may include a first reel 14a, a second reel 14b, a third reel, 14c, a fourth reel 14d, and a fifth wheel 14e, wherein the third reel 14c is centrally located on the display 12. The display 12 may also include a trigger row 26 that includes a plurality of trigger symbol locations 29, wherein each trigger symbol location 29 corresponds to at least one of the plurality of reels 14. The plurality of trigger symbol locations 29 may also include a second trigger token 28. According to an aspect, the second trigger token 28 may be a shark or any other suitable symbol, word, or phrase according to the theme of the system 10 for a game of chance.

According to aspects of the present disclosure, the system 10 for a game of chance includes an expanding prize feature, which may require a variety of conditions before being triggered. In an embodiment, one condition to trigger the expanding prize feature includes the first trigger token 22 landing on one of the plurality of symbol locations 16 of the plurality of reels 14 after the plurality of reels 14 stop spinning. In some embodiments, the expanding prize feature may only be triggered by the first trigger token 22 landing on one of the plurality of symbol locations of the plurality of reels 14. For example, to trigger the expanding prize feature the first trigger token 22 may be required to land on the third reel 14c (i.e., the central or middle one of the plurality of reels 14). In an embodiment, the first trigger token 22 may transform to visually indicate that the first condition has been satisfied. For example, the first trigger token 22 may transform from a pirate, to a phrase or logo such as “Slice n’ Dice, as shown in FIGS. 1A-1C.

According to aspects of the present disclosure, a second condition may be required to trigger the expanding prize feature of the system 10 for a game of chance. The second condition may include at least one of the prize token 18 or the bonus token 20 being displayed in one of the plurality of symbol locations 16 of at least one of the plurality of reels 14. In an embodiment, the expanding prize feature may not be triggered by the general token 24 (e.g., any token other than the prize token 18, the bonus token 20, or the first trigger token 22) as illustrated by the characters “A”, “K”, “Q”, “J”, “10”, and “9” in FIGS. 1A and 1C.

According to aspects of the present disclosure, a third condition may be required to trigger the expanding prize feature. The third condition may include at least one second trigger token 28 being displayed in at least one of the plurality of trigger symbol locations 29 of the trigger row 26 that corresponds to the at least one of the plurality of reels 14 containing at least one of the prize token 18 or the bonus token 20. For example, as shown in FIGS. 1A and 1C, the first reel 14a and the fourth reel 14d contain one prize token 18, the second reel 14b and the fifth reel 14e contain two prize tokens 18, and the third reel 14c contains a bonus token 20. The trigger reel 26 also contains the second trigger token 28 corresponding to each of the plurality of reels 14. According to the example shown in FIGS. 1A and 1C, all of the plurality of reels 14 will trigger the expanding prize feature. In some embodiments, to indicate that either the second or third condition has been satisfied for the plurality of reels 14, certain visual effects may be displayed within the plurality of reels 14. For example, the visual effects may include a stream of arrows 37 as shown in in FIG. 1A, an animation of a shark rising out of the water, or the like. The expanding prize feature may be applied to one or all of the symbol locations 16 displaying at least one of the prize token 18 or the bonus token 20 within the respective plurality of reels 14 according to aspects of the present disclosure.

It is within the scope of this disclosure that the expanding prize feature may be triggered by other means or conditions not explicitly described herein. For example, only one or more than two trigger tokens may be required and may arrive by means other than the spinning of a reel. Further examples include a collective trigger caused by one or a plurality of players using the system 10 for a game of chance.

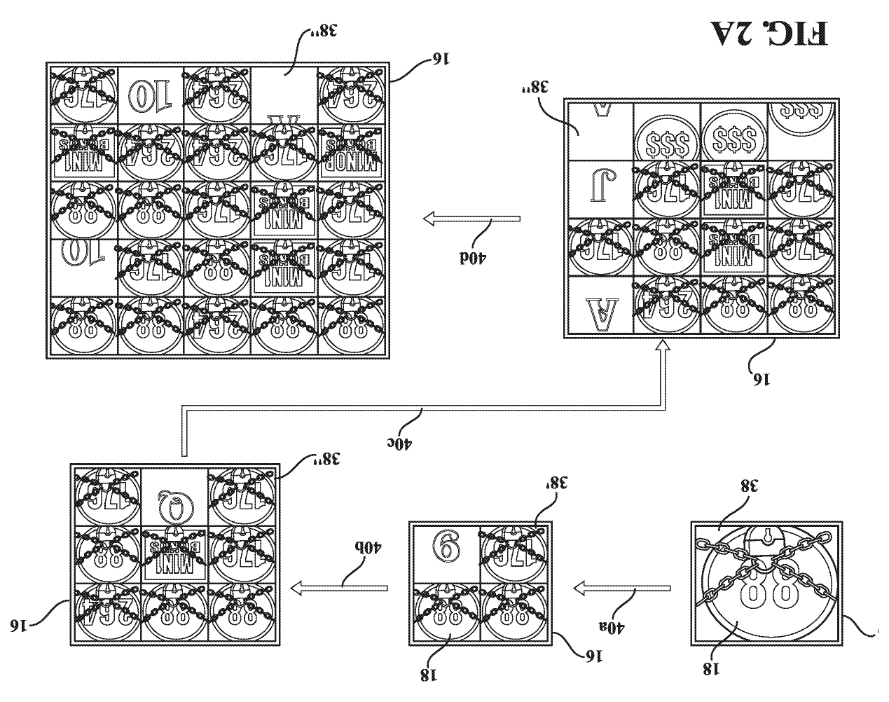

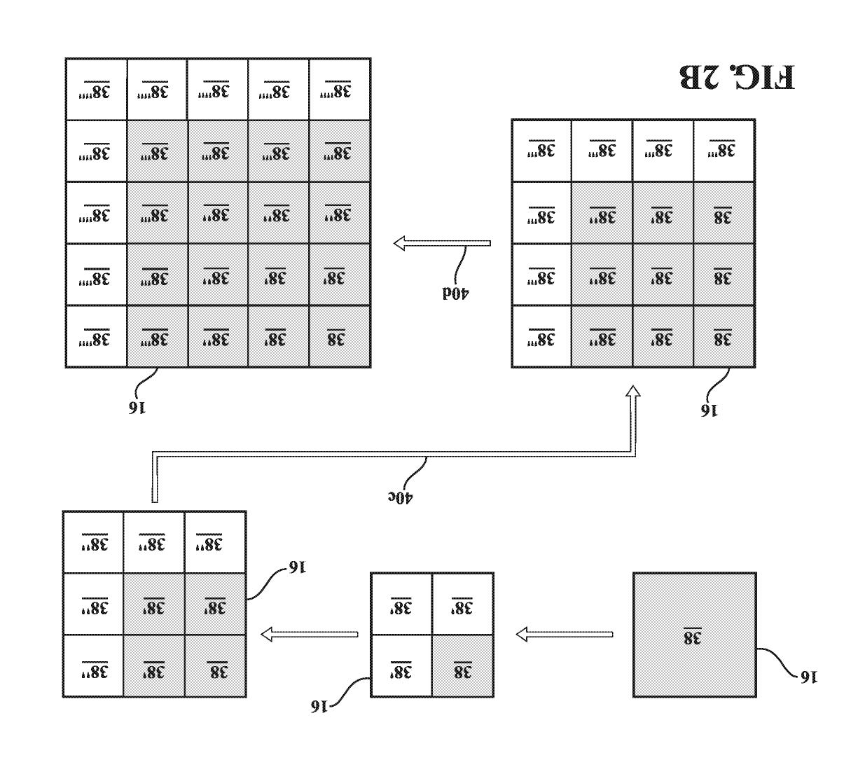

As shown in FIGS. 2A and 2B, the plurality of symbol locations 16 include a first symbol position 38 for displaying the game symbols. In an embodiment, the expanding prize feature includes sub-dividing at least one of the plurality of symbol locations 16 that contain at least one of the prize token 18 or the bonus token 20 when a trigger condition has been met. The expanding prize feature sub-divides at least one of the plurality of symbol locations 16 to create additional symbol positions 38’-38’’’’ to be populated with additional game symbols. According to an embodiment, the additional symbol positions 38’-38’’’’ may feature the prize token 18, the bonus token 20, or the general token 24. In an aspect, the symbol location 16, the symbol position 38, or the game symbol may change visually during the expanding prize feature. For example, the symbol position 16 may expand or increase in size to accommodate the additional symbol positions 38’-38’’’’, and the size of the game symbol (e.g., the prize token 18, or the bonus token 20) may reduce to accommodate the increased number of game symbols. Accordingly, the expansion of the symbol location 16 may result in overlapping or covering an adjacent symbol location 16 or reel 14.

According to an aspect of the present disclosure, the expanding prize feature is repetitive, progressive, and continuous. As shown in FIGS. 2A and 2B, when the expanding prize feature is triggered, the symbol location 16 undergoes a first subdivision 40a, wherein the symbol location 16 including a first symbol position 38, is subdivided to include a plurality of second symbol positions 38’. In an embodiment the prize token 18 or the bonus token 20 that is located in symbol position prior to sub-division is retained while the new symbol position is populated. For example, before symbol position 16 undergoes a first subdivision 40a, the prize token 18 or the bonus token 20 located in the first symbol position 38 remains, while the plurality of second symbol positions 38’ are populated with new game symbols. In an embodiment a second subdivision 40b may take place, if a second trigger condition is met. The second trigger condition may include at least one of the prize token 18, or the bonus token 20 being displayed in each of the plurality of second symbol positions 38’. If the second trigger condition is met, the symbol location 16 may be subdivided again to include a third plurality of symbol positions 38’’ to be populated with new game symbols.

In other embodiments, the expanding prize feature may be repeated any number of times or up to a specific limit. For example, a third subdivision 40c, may take place when a third trigger condition has been met, resulting in the symbol location 16 being subdivided to include a fourth plurality of symbol positions 38’’’ to be populated with new game symbols. The expanding prize feature may repeat once more with a fourth subdivision 40d, when a fourth trigger condition is met, resulting in the symbol location 16 being subdivided to include a plurality of fifth symbol positions 38’’’’ to be populated with new game symbols. According to an aspect, the first subdivision 40a may result in a total of four symbol positions, the second subdivision 40b may result in a total of nine symbol positions, the third subdivision 40c may result in a total of sixteen symbol positions, and the fourth subdivision 40d may result in a total of twenty-five symbol positions.

In some embodiments, the reveal or arrival of the new game symbols may include visuals or animation, including but not limited to spinning and stopping the new game symbols, or phasing in the new game symbols. In an aspect, the subdivision of the symbol location 16 may generate a grid. However, in some embodiments, the division of the symbol location 16 and/or symbol positions 38 may generate other shapes in a continuous, discontinuous, or alternating manner. For example, the symbol location 16 may change from a square shape to a circular, triangular, pyramidal, star-like, or other type of polygonal shape, wherein the shape of the symbol location 16 increases with each division and/or changes between the aforementioned step. In some embodiments, the grid or matrix of the symbol location 16 subdivides into new symbol positions 38’-38’’’’ in sequential order from top to bottom, and left to right.

In an embodiment, a prize condition may be met during the expanding prize feature. The prize condition may include all symbol positions 38’-38’’’’, being populated with at least one of the prize token 18 or the bonus tokens 20. When the prize condition is met, a player may be awarded a bonus or jackpot prize. The bonus or jackpot prize may correspond to the maxi bonus amount 36c, the major bonus amount 36d, or the grand bonus amount 36e as shown in FIG. 1A.

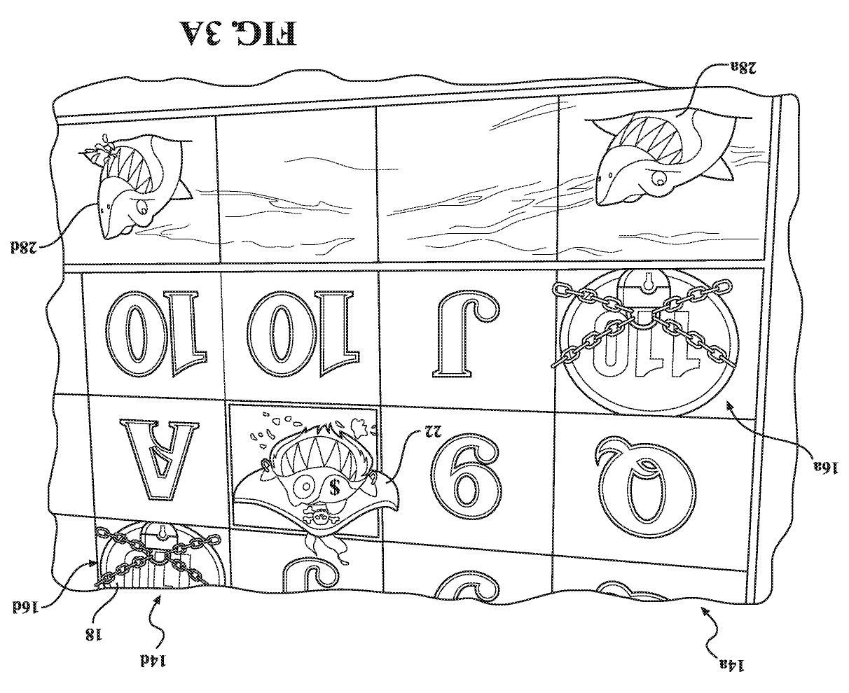

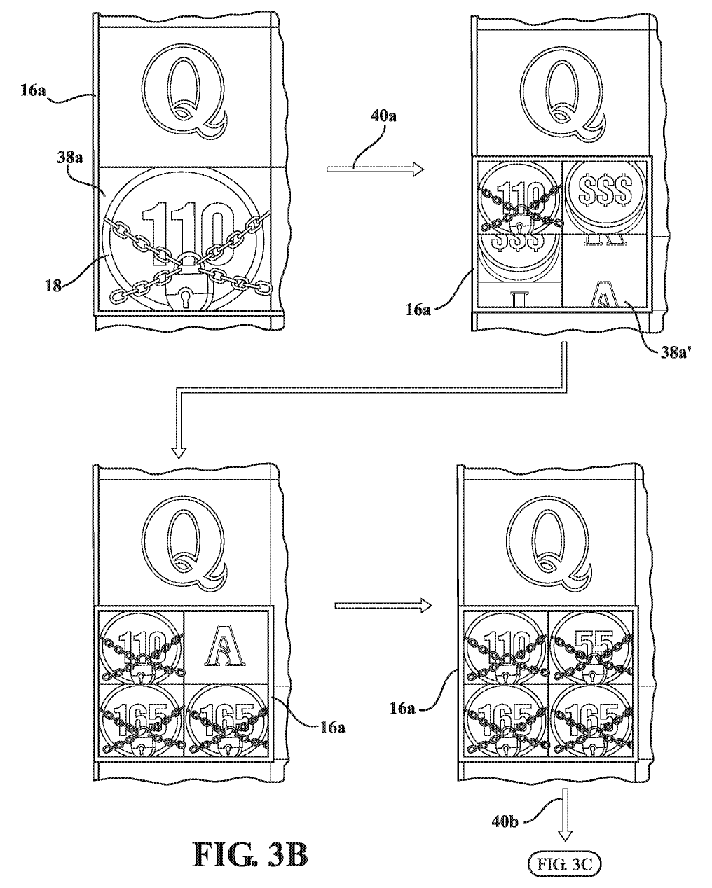

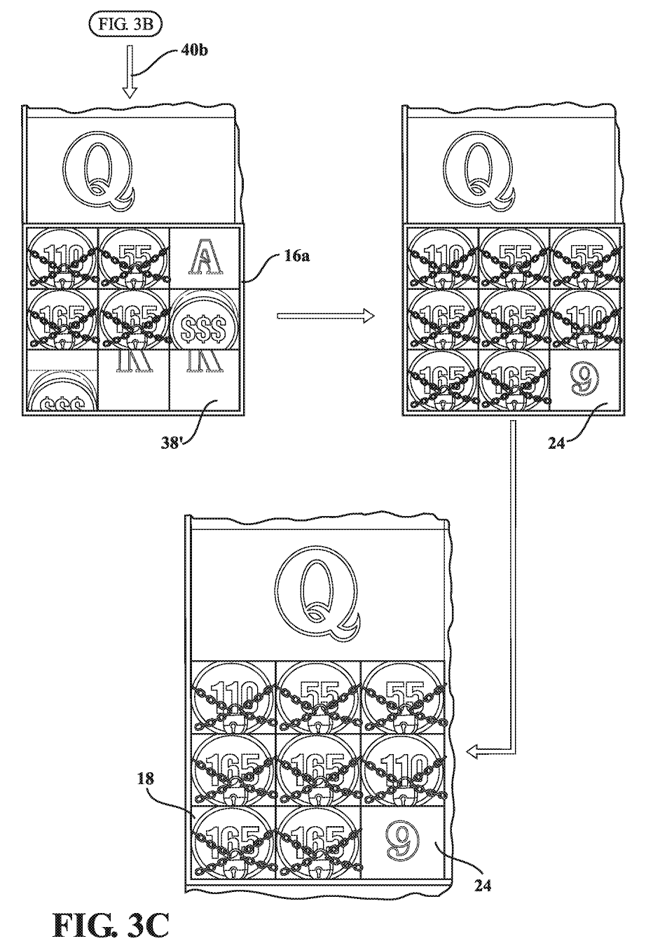

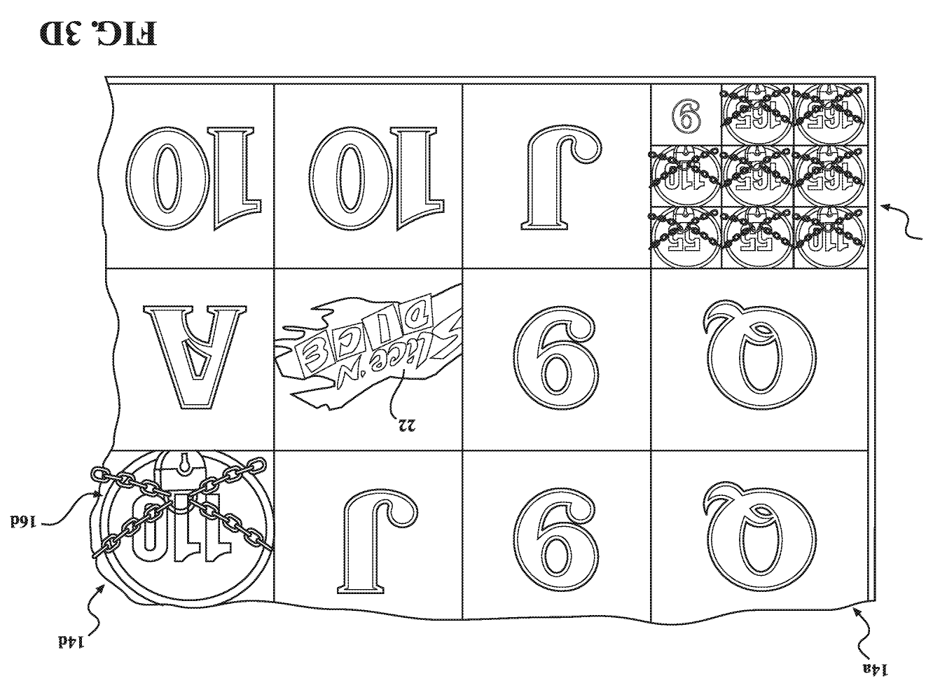

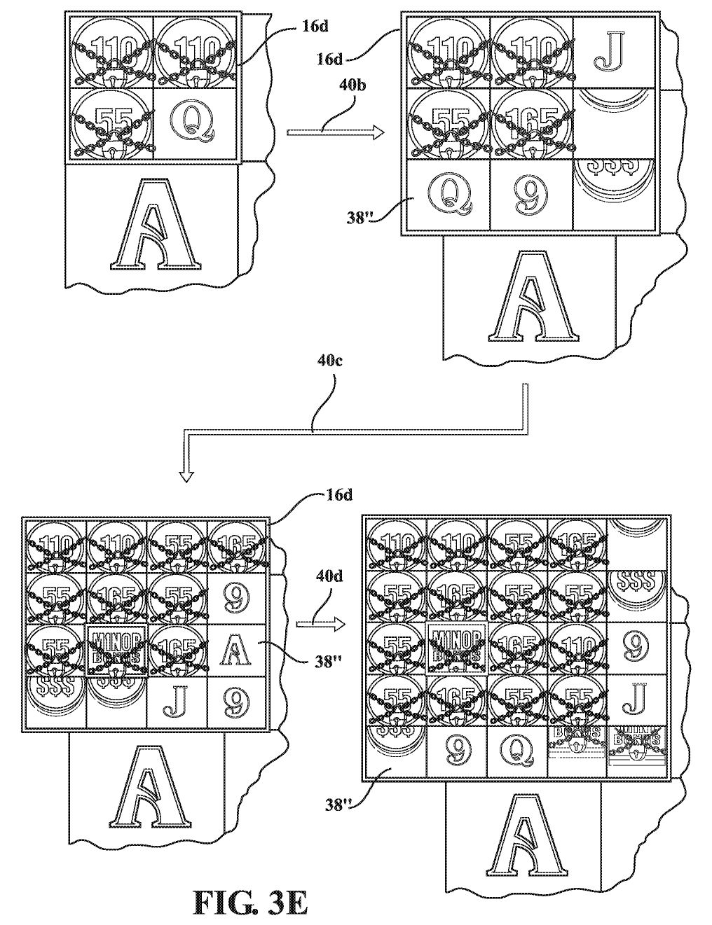

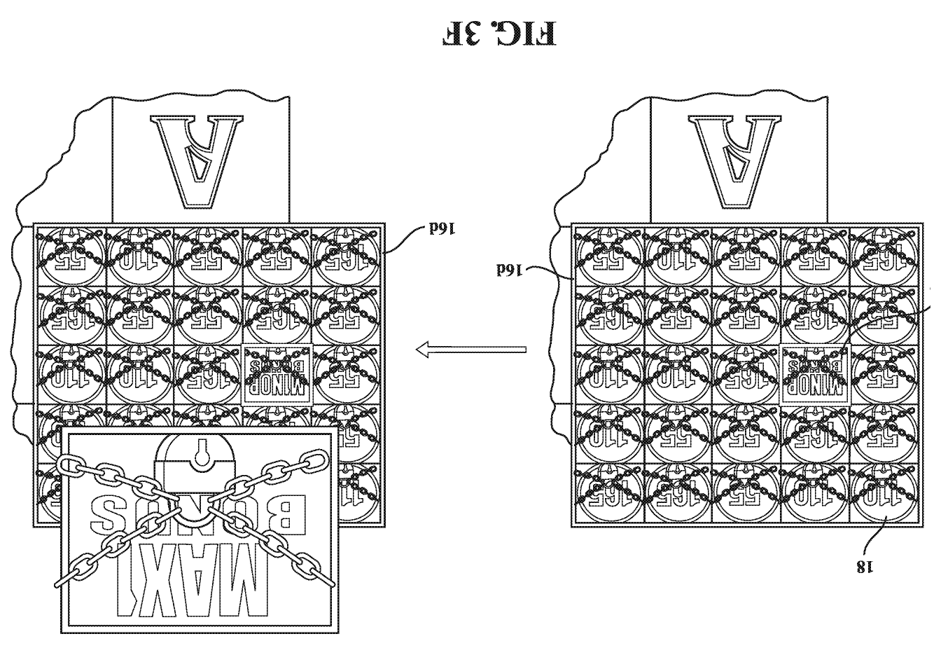

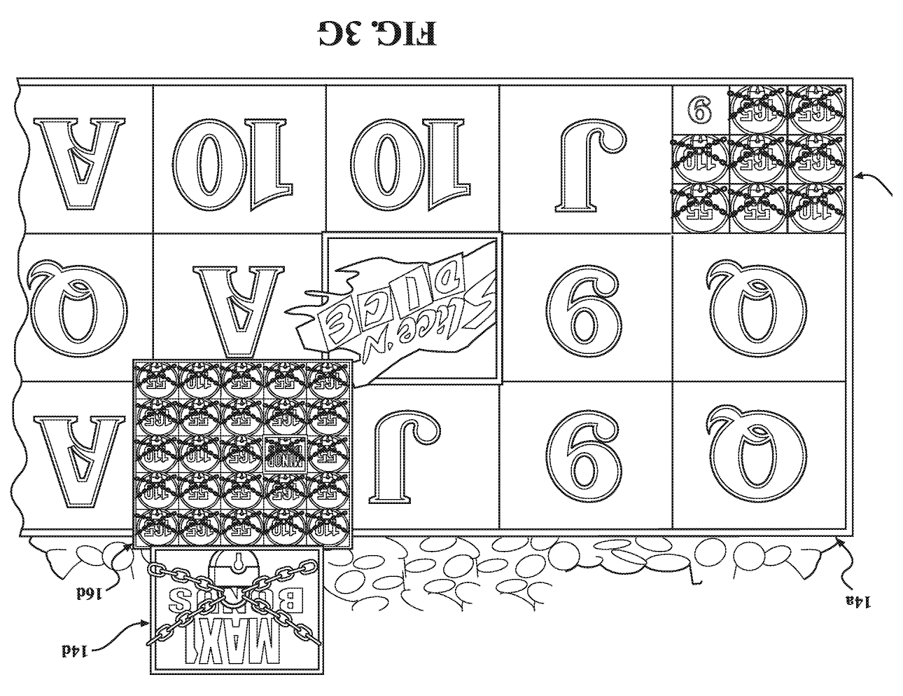

FIGS. 3A-G shows screenshots of the system 10 for a game of chance during gameplay when the expanding prize feature is triggered. In FIG. 3A, the first trigger token 22 is present in the third reel 14c, the prize tokens 18 are present in the first reel 14a and the fourth reel 14d, and the second trigger tokens 28a, 28d are present beneath the first reel 14a and the fourth reel 14d. Accordingly, the expanding prize feature is triggered for the symbol locations 16a, 16d in the first reel 14a and the fourth reel 14d. The first trigger token 22 transforms from a pirate to the logo “Slice n’ Dice” (as shown in FIG. 3D). FIG. 3B shows the first subdivision 40a of the symbol location 16a to include three of the second symbol positions 38a’ and a spinning animation to reveal the prize tokens 18 landing in each of the second symbol positions 38a’. FIG. 3C shows the second division 40b of the symbol location 16a in which the size of the symbol location 16a is increased (e.g., the border of the symbol location 16a extends into the second reel 14b and is larger than the adjacent symbol location 16a in the first reel 14a) and the symbol location 16a now includes a total of nine symbol positions 38a-38a’’. However, one of the third symbol positions 38a’’ has revealed a general token 24 (e.g., a “9”). Due to one of the third symbol positions 38a’’ displaying a general token 24, the expanding prize feature concludes and the symbol location 16a does not subdivide any further. FIG. 3D shows the final results of the symbol location 16a and the decrease in size of the symbol location 16a and the symbol positions 38a-38a’’ so as to return to an original size and fit within the standard bounds of the first reel 14a.

FIG. 3E shows the symbol location 16d progressing through the first, second, third, and fourth subdivisions 40a-40d. FIG. 3F shows the symbol location 16d after the fourth subdivision 40d (i.e., the final division) wherein the symbol positions 38d-38d’’’’ all contain the prize token 18 or the bonus tokens 20. As a result, the player has been awarded the jackpot prize corresponding to the maxi bonus 36c. FIG. 3G shows all of the plurality of reels 14. The system 10 for a game of chance may then continue to resolve any actions in the fifth reel 14e, begin a new round, begin a bonus game, or the like.

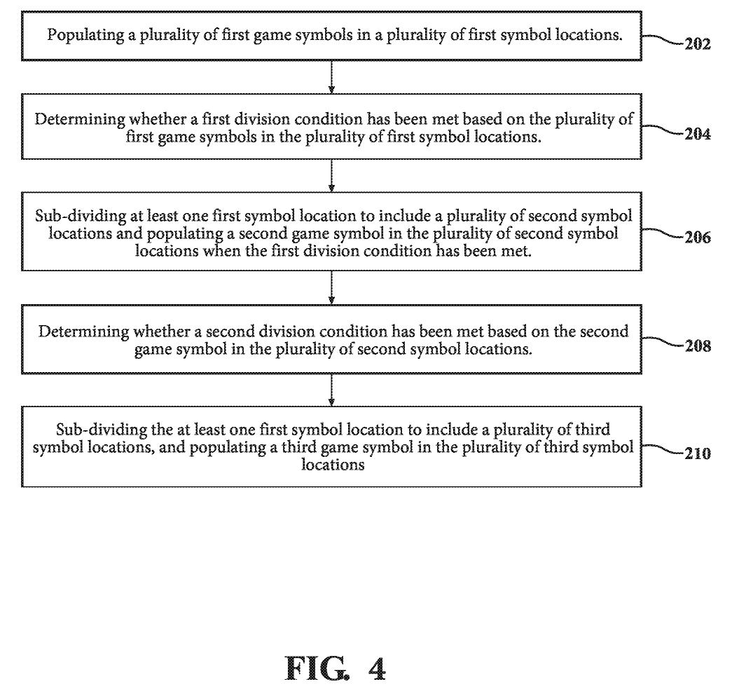

FIG. 4 depicts a method 200 for a game of chance, according to an embodiment of the present disclosure. The method 200 begins at step 202, by populating a plurality of first game symbols in a plurality of first symbol locations. Next, the method 200 continues at step 204 by determining whether a first division condition has been met based on the plurality of first game symbols in the plurality of first symbol locations. The next step 206 entails, sub-dividing at least one first symbol location to include a plurality of second symbol locations and populating a second game symbol in the plurality of second symbol locations when the first division condition has been met. Next, step 208 includes determining whether a second division condition has been met based on the second game symbol in the plurality of second symbol locations. Method 200 concludes at the next step 210 by sub-dividing the at least one first symbol location to include a plurality of third symbol locations, and populating a third game symbol in the plurality of third symbol locations.

According to aspects of the present disclosure the system 10 for a game of chance, and the method 200 for a game of chance may include visual effects, auditory effects, and other sensory effects (e.g., vibration, olfactory, etc.) to increase the enjoyment and excitement of the player. For example, the display 12 may feature certain colors (steady, changing, or the like) and animations (e.g., the spinning of the plurality of reels 14, the transformation, movement, or action of the game symbols, the highlighting of the plurality of reels 14 that meet the requirements for the expanding prize feature, the increase in size of the symbol location 16, etc., the individual spinning or animation of the new symbol positions 38’, 38’’, 38’’’, 38’’’’). Another example is the accompanying sound to specific events and visual effects. The combination of the visual and auditory effects produce a feeling that “it will never end!” for the player, and the more the expanding prize feature goes on (e.g., multiple sub-divisions), the more the player feels the excitement and the potential for big wins or prizes. Accordingly, the expanding prize feature provides an improved experience as compared to other games of chance.

The systems and methods described herein may be configured to use the existing hardware platform to manage and optimize power distribution. It provides a critical interface for power management in data centers, particularly for high-demand AI and HPC workloads.

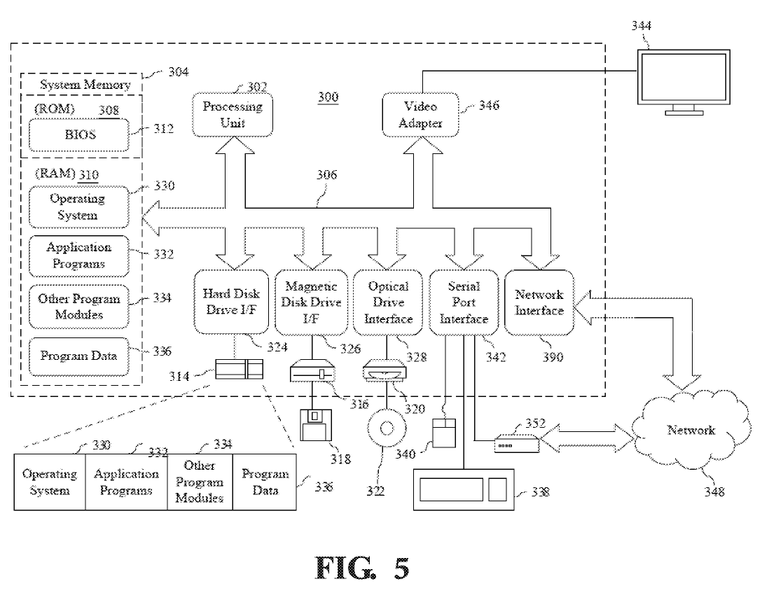

As shown in FIG. 5, processor-based computer system 300 includes one or more processors, referred to as processor circuit 302, a system memory 304, and a bus 306 that couples various system components including system memory 304 to processor circuit 302. The system 300 may be configured to perform various aspects of the systems and methods descried herein.

Processor circuit 302 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 302 may execute program code stored in a computer readable medium, such as program code of operating system 330, application programs 332, other programs 334, etc. Bus 306 represents one or more of any of several types of bus structures, including a memory bus or memory controller, a peripheral bus, an accelerated graphics port, and a processor or local bus using any of a variety of bus architectures. System memory 304 includes read only memory (ROM) 308 and random access memory (RAM) 310. A basic input/output system 312 (BIOS) is stored in ROM 308.

Processor-based computer system 300 also has one or more of the following drives: a hard disk drive 314 for reading from and writing to a hard disk, a magnetic disk drive 316 for reading from or writing to a removable magnetic disk 318, and an optical disk drive 320 for reading from or writing to a removable optical disk 322 such as a CD ROM, DVD ROM, or other optical media. Hard disk drive 314, magnetic disk drive 316, and optical disk drive 320 are connected to bus 306 by a hard disk drive interface 324, a magnetic disk drive interface 326, and an optical drive interface 328, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards, digital video disks, RAMs, ROMs, and other hardware storage media.

A number of program modules may be stored on the hard disk, magnetic disk, optical disk, ROM, or RAM. These programs include operating system 330, one or more application programs 332, other programs 334, and program data 336. Application programs 332 or other programs 334 may include, for example, computer program logic (e.g., computer program code or instructions) for implementing the systems and methods described herein.

A user may enter commands and information into processor-based computer system 300 through input devices such as keyboard 338 and pointing device 340. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor circuit 302 through a serial port interface 342 that is coupled to bus 306, but may be connected by other interfaces, such as a parallel port, game port, or a universal serial bus (USB).

A display screen 344 is also connected to bus 306 via an interface, such as a video adapter 346. Display screen 344 may be external to, or incorporated in processor-based computer system 300. Display screen 344 may display information, as well as being a user interface for receiving user commands and/or other information (e.g., by touch, finger gestures, virtual keyboard, etc.). In addition to display screen 344, processor-based computer system 300 may include other peripheral output devices (not shown) such as speakers and printers.

Processor-based computer system 300 is connected to a network 348 (e.g., the Internet) through an adaptor or network interface 350, a modem 352, or other means for establishing communications over the network. Modem 352, which may be internal or external, may be connected to bus 306 via serial port interface 342, as shown in FIG. 5, or may be connected to bus 306 using another interface type, including a parallel interface.

As used herein, the terms "computer program medium," "computer-readable medium," and “computer-readable storage medium” are used to generally refer to physical hardware media such as the hard disk associated with hard disk drive 314, removable magnetic disk 318, removable optical disk 322, other physical hardware media such as RAMs, ROMs, flash memory cards, digital video disks, zip disks, MEMs, nanotechnology-based storage devices, and further types of physical/tangible hardware storage media (including system memory 304 of FIG. 5). Such computer-readable storage media are distinguished from and non-overlapping with communication media (do not include communication media). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media.

As noted above, computer programs and modules (including application programs 332 and other programs 334) may be stored on the hard disk, magnetic disk, optical disk, ROM, RAM, or other hardware storage medium. Such computer programs may also be received via network interface 350, serial port interface 342, or any other interface type. Such computer programs, when executed or loaded by an application, enable processor-based computer system 300 to implement features of embodiments discussed herein. Accordingly, such computer programs represent controllers of processor-based computer system 300.

Implementations of the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably.

As used herein, the term module can include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module can include an application specific integrated circuit (ASIC), a Field Programmable Gate Array (FPGA), a circuit, digital logic circuit, an analog circuit, a combination of discrete circuits, gates, and other types of hardware or combination thereof. In other embodiments, a module can include memory that stores instructions executable by a controller to implement a feature of the module.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

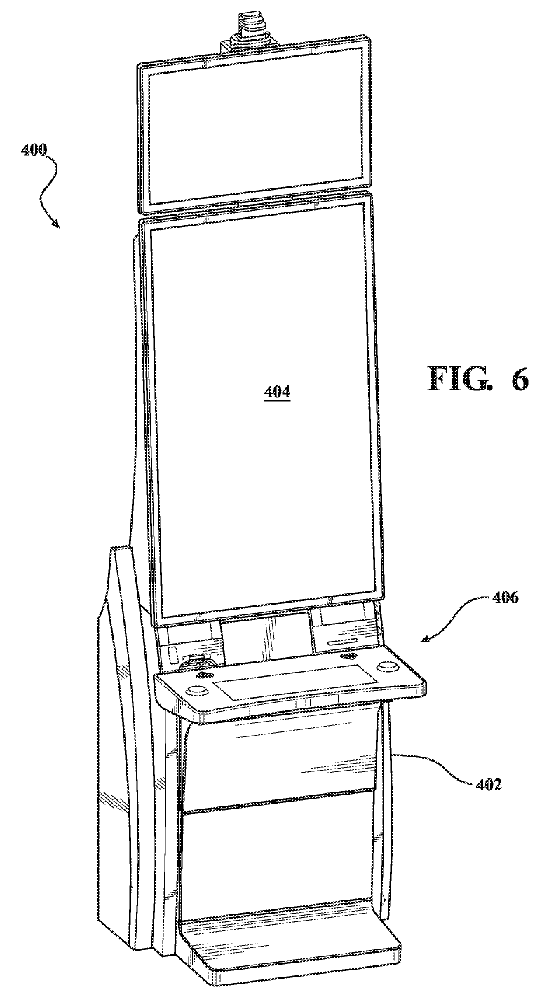

FIG. 6 shows a gaming machine 400 that may be used to implement the system 10 for a game of chance and the expanding prize feature according to the present disclosure. The gaming machine 400 may include a cabinet 402 for housing electronic components, a display 404 (and other auxiliary displays), buttons and/or a touchscreen 406 for allowing the player to select a bet level, game modes, select a type of game or game feature, and imitate a play of the game. Other forms of gaming machines according to the invention may include switches, joysticks, or other mechanical input devices, and/or virtual buttons and other controls implemented on a suitable touchscreen video display. It will be appreciated that gaming machines may also include a number of other player interface devices in addition to devices that are considered player controls for use in playing a particular game. The gaming machine 400 may also include a currency/voucher acceptor, a player card reader having a player card input, and a voucher/receipt printer having a voucher/receipt output. The gaming machine 400 includes audio speakers for generating an audio output to enhance the user's playing experience. Numerous other types of devices may be included in gaming machines that may be used according to the present disclosure.

Those familiar with data processing devices and systems will appreciate that other basic electronic components will be included in gaming machine 400 such as a power supply, cooling systems for the various system components, audio amplifiers, and other devices that are common in gaming machines. Additional electronic components include a central processing unit (CPU) along with random access memory and nonvolatile memory or a storage device, which are connected on a system bus with an audio controller, a network controller, a touchscreen controller, and a serial interface. Further electronic components include a graphics processor connected on the bus and the display device 404 and any auxiliary display devices. These additional devices are omitted from the drawings so as not to obscure the present invention in unnecessary detail.

In further embodiments, a game processor connects to a user interface such that a player may enter input information and the game processor may respond according to its programming, such as to apply a wager and initiate execution of a game. The same processor also may connect through the network controller to a gaming network, such as example casino server network. The casino server network may be implemented over one or more site locations and include host server, remote game server (which may be configured to provide game processor functionality including determining game outcomes and providing audio/visual instructions to a remote gaming device), central determinant server (which may be configured to determine lottery, bingo, or other centrally determined game outcomes and provide the information to networked gaming machines 400 providing lottery and bingo-based wagering games to patrons), progressive server (which may be configured to accumulate a progressive pool from a portion of wagering proceeds or operator marketing funds and to award progressive awards upon the occurrence of a progressive award winning event to one or more networked gaming machines 400), player account server (which may be configured to collect and store player information and/or awards and to provide player information to gaming machines 400 after receiving player identification information such as from a player card), and accounting server (which may be configured to receive and store data from networked gaming machines 400 and to use the data to provide reports and analyses to an operator). Through its network connection, gaming machine 400 may be monitored by an operator through one or more servers such as to assure proper operation, and, data and information may be shared between gaming machine 400 and respective of the servers in the network such as to accumulate or provide player promotional value, to provide server-based games, or to pay server-based awards.

Obviously, many modifications and variations of the present invention are possible in light of the above teachings and may be practiced otherwise than as specifically described while within the scope of the appended claims. These antecedent recitations should be interpreted to cover any combination in which the inventive novelty exercises its utility. The use of the word "said" in the apparatus claims refers to an antecedent that is a positive recitation meant to be included in the coverage of the claims whereas the word "the" precedes a word not meant to be included in the coverage of the claims.

It should be understood that aspects of the methods, processes, products, etc. as disclosed herein may be applied to casino-style games. Additionally and alternatively, the aspects may be applied to other non-casino games, such as raffles, fundraisers, learning games, etc.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

What is claimed is:

1. A method for a game of chance, the method including:
populating a plurality of first game symbols in a plurality of first symbol locations;
determining whether a first division condition has been met based on the plurality of first game symbols in the plurality of first symbol locations;
sub-dividing at least one first symbol location to include a plurality of second symbol locations and populating a second game symbol in the plurality of second symbol locations when the first division condition has been met;
determining whether a second division condition has been met based on the second game symbol in the plurality of second symbol locations; and
sub-dividing the at least one first symbol location to include a plurality of third symbol locations, and populating a third game symbol in the plurality of third symbol locations.

2. The method of claim 1, wherein the method is performed on a gaming system, the gaming system including:
at least one graphical user interface for displaying aspects of the game of chance to users;
at least one input device for receiving inputs from the users;
one or more memory devices storing instructions; and
one or more processing devices communicatively coupled to the at least one graphical user interface, the at least one input device, and the one or more memory devices.

3. The method of claim 2, wherein the at least one graphical user interface includes a plurality of graphical user interfaces, and wherein the at least one input device includes a plurality of input devices such that a plurality of users may interact with the gaming system from locations remote from one another.

4. The method of claim 2, further comprising:
determining whether a prize condition has been met based on the third game symbol in the plurality of third symbol locations.

5. The method of claim 2, further comprising:
determining whether a third division condition has been met based on the third game symbol in the plurality of third symbol locations; and
sub-dividing the at least one first symbol location to include a plurality of fourth symbol locations, and populating a fourth game symbol in the plurality of fourth symbol locations.

6. The method of claim 5, further comprising:
determining whether a prize condition has been met based on the fourth game symbol in the plurality of fourth symbol locations.

7. The method of claim 5, further comprising:
determining whether a fourth division condition has been met based on the fourth game symbol in the plurality of fourth symbol locations; and
sub-dividing the at least one first symbol location to include a plurality of fifth symbol locations, and populating a fifth game symbol in the plurality of fifth symbol locations.

8. The method of claim 7, further comprising:
determining whether a prize condition has been met based on the fifth game symbol in the plurality of fifth symbol locations.

9. A system for a game of chance, comprising:
at least one graphical user interface for displaying aspects of the game of chance to users;
at least one input device for receiving inputs from the users;
one or more memory devices storing instructions; and
one or more processing devices communicatively coupled to the at least one graphical user interface, the at least one input device, and the one or more memory devices, wherein the one or more processing execute the instructions to:
populate a plurality of first game symbols in a plurality of first symbol locations;
determine whether a first division condition has been met based on the plurality of first game symbols in the plurality of first symbol locations;
sub-divide at least one first symbol location to include a plurality of second symbol locations and populate a second game symbol in the plurality of second symbol locations when the first division condition has been met;
determine whether a second division condition has been met based on the second game symbol in the plurality of second symbol locations; and
sub-divide the at least one first symbol location to include a plurality of third symbol locations, and populate a third game symbol in the plurality of third symbol locations.

10. The system of claim 9, wherein the memory further includes instructions that, when executed by the processor, cause the processor to:
determine whether a prize condition has been met based on the third game symbol in the plurality of third symbol locations.

11. The system of claim 9, wherein the memory further includes instructions that, when executed by the processor, cause the processor to:
determine whether a third division condition has been met based on the third game symbol in the plurality of third symbol locations; and
sub-divide the at least one first symbol location to include a plurality of fourth symbol locations, and populate a fourth game symbol in the plurality of fourth symbol locations.

12. The system of claim 11, wherein the memory further includes instructions that, when executed by the processor, cause the processor to:
determine whether a prize condition has been met based on the fourth game symbol in the plurality of fourth symbol locations.

13. The system of claim 11, wherein the memory further includes instructions that, when executed by the processor, cause the processor to:
determining whether a fourth division condition has been met based on the fourth game symbol in the plurality of fourth symbol locations; and
sub-dividing the at least one first symbol location to include a plurality of fifth symbol locations, and populating a fifth game symbol in the plurality of fifth symbol locations.

14. The system of claim 13, wherein the memory further includes instructions that, when executed by the processor, cause the processor to:
determining whether a prize condition has been met based on the fifth game symbol in the plurality of fifth symbol locations.

15. A tangible, non-transitory computer-readable medium storing instructions that, when executed, cause one or more processing devices to:
populate a plurality of first game symbols in a plurality of first symbol locations;
determine whether a first division condition has been met based on the plurality of first game symbols in the plurality of first symbol locations;
sub-divide at least one first symbol location to include a plurality of second symbol locations and populate a second game symbol in the plurality of second symbol locations when the first division condition has been met;
determine whether a second division condition has been met based on the second game symbol in the plurality of second symbol locations; and
sub-divide the at least one first symbol location to include a plurality of third symbol locations, and populate a third game symbol in the plurality of third symbol locations.

16. The computer-readable medium of claim 15, wherein the computer-readable medium further includes instructions that, when executed by the processor, cause the processor to:
determine whether a prize condition has been met based on the third game symbol in the plurality of third symbol locations.

17. The computer-readable medium of claim 15, wherein the computer-readable medium further includes instructions that, when executed by the processor, cause the processor to:
determine whether a third division condition has been met based on the third game symbol in the plurality of third symbol locations; and
sub-divide the at least one first symbol location to include a plurality of fourth symbol locations, and populate a fourth game symbol in the plurality of fourth symbol locations.

18. The computer-readable medium of claim 17, wherein the computer-readable medium further includes instructions that, when executed by the processor, cause the processor to:
determine whether a prize condition has been met based on the fourth game symbol in the plurality of fourth symbol locations.

19. The computer-readable medium of claim 17, wherein the computer-readable medium further includes instructions that, when executed by the processor, cause the processor to:
determining whether a fourth division condition has been met based on the fourth game symbol in the plurality of fourth symbol locations; and
sub-dividing the at least one first symbol location to include a plurality of fifth symbol locations, and populating a fifth game symbol in the plurality of fifth symbol locations.

20. The computer-readable medium of claim 19, wherein the computer-readable medium further includes instructions that, when executed by the processor, cause the processor to:
determining whether a prize condition has been met based on the fifth game symbol in the plurality of fifth symbol locations.
